(19) United States
(12) Patent Application Publication
(10) Pub. No.: US 2005/0195267 A1
(43) Pub. Date: Sep. 8, 2005

(54) Drive control method and device for light emitting element, and electronic apparatus using the same

(75) Inventors: Junji Hayashi, Saitama (JP); Nobuo Katsuma, Saitama (JP); Akira Mizuyoshi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/067,734

(22) Filed: Mar. 1, 2005

(30) Foreign Application Priority Data
Mar. 2, 2004 (JP) 2004-057832
Sep. 21, 2004 (JP) 2004-274120

(51) Int. Cl. B41J 2/385; G03G 13/04

(52) U.S. Cl. 347/130

(57) ABSTRACT

Before shipment, an LED column in the direct color thermal printer is driven by a maximum current for maximum light emission. While driving, a voltmeter and a light amount sensor measure temporal change in drive voltage and light amount of the LED column. The system controller, based on the measurement result, obtains a slope and an intercept of the first-order equation representing the linear portion for the response of the light amount to variation of the drive voltage, and a threshold voltage at a point the response changes from linear to nonlinear. These values are stored in EEPROM. When driving the two dimensional LED array, the system controller obtains a target drive voltage with referring to the drive profile, then controls the current such that the drive voltage of the light emitting element becomes the target drive voltage and does not become below the threshold voltage.

### BACKGROUND OF THE INVENTION

1. Field of the Invention

The present invention relates to a drive control method and a device for a light emitting element, and an electronic apparatus using the same.

2. Background Arts

A color thermal printer prevalent nowadays performs full color printing to a color thermosensitive recording paper, which is formed of cyan, magenta, and yellow thermosensitive coloring layers overlaid on a support sequentially. This color thermal printer presses a thermal head, which has plural heat elements in linear arrangement, against the in-conveyance color thermosensitive recording paper to perform a thermal recording. The thermal recording is sequentially performed in each thermosensitive coloring layer, and then the recorded thermosensitive coloring layers are exposed to ultraviolet ray from an optical fixing unit so that the once recorded thermosensitive coloring layers can avoid re-coloring in the thermal recording to the following thermosensitive coloring layer. The light source of the optical fixing unit has been an ultraviolet lamp. However, the recently proposed light source to enhance the fixing efficiency is a two dimensional light emitting element array, which is constituted of sets of light emitting elements such as LED.

Since the light emitting element suchlike LED is made with semiconductors, its light amount and emission spectrum fluctuate depending on the ambient temperature. Consequently, the Japanese patent laid-open publication No. 2003-246088 discloses a color thermal printer which measures temperature of a light emitting element or ambient air, then controls the current to the light emitting element based on the measured temperature so as to compensate the fluctuations in the light amount and the emission spectrum.

However, the above described device has a defect to require a temperature sensor such as a thermocouple or a thermistor. Moreover, some factors such as a measuring time-lag due to the heat conduction or thermal resistance of the temperature sensor lead the errors of measurement, resulting in the inaccurate current control to the light emitting element.

### SUMMARY OF THE INVENTION

In view of the foregoing, a primary object of the present invention is to provide a drive control method and a device for a light emitting element, which allow for controlling current of the light emitting element precisely.

Another object of the present invention is to provide a drive control method and a device for a light emitting element, which require no temperature sensing component to control current of the light emitting element precisely.

Still another object of the present invention is to provide an electronic apparatus, which allows for stably driving a light source having the light emitting element.

Still another object of the present invention is to provide an electronic apparatus, which causes no increase in cost to stably drive a light source.

To achieve the above and other objects, a drive control method of the present invention comprises a measuring step to measure at least one light emitting element, which is driven by constant current, for temporal change in the drive voltage and the light amount of the light emitting element, a creating step to create a drive profile for obtaining a target drive voltage corresponding to targeted light amount according to the measurement result, and a controlling step to control the current of the light emitting element such that the drive voltage of the light emitting element becomes the target drive voltage when illuminating the light emitting element.

In the measuring step, the light emitting element is driven by a maximum current for maximum light emission. Then, a drive voltage is obtained at a point where the response of the light amount to variation of the drive voltage changes from linear to nonlinear. This obtained drive voltage is stored as a threshold voltage, together with the drive profile. The drive profile includes a slope and an intercept of a first-order equation representing a liner portion of the response. In the controlling step, the current of the light emitting element is controlled such that the drive voltage of the light emitting element does not become below the threshold voltage.

In addition, the light emitting element may be plural light emitting elements, which form plural element columns. The drive voltage and the light amount in every element column are measured in the measuring step. In the creating step, the drive profile is created based on the measurement results of all element columns or normalizing the drive voltage of other element columns by that of a single element column representative among the plural element columns. The current of each element column is individually controlled.

A drive control device of the present invention comprises a data processing means for creating a drive profile, a storing means for storing the drive profile, and a current control means for controlling current of the light emitting element.

The data processing means obtains a drive voltage, from the measurement result, at a point where the response of the light amount to variation of the drive voltage changes from linear to nonlinear. The storing means stores this obtained drive voltage as a threshold voltage, together with the drive profile. The current control means controls the current of the light emitting element such that the drive voltage of the light emitting element does not become below the threshold voltage.

In addition, the light emitting element may be plural light emitting elements, which form plural element columns. The data processing means creates the drive profile based on the measurement results of all element columns or normalizing the drive voltage of other element columns by that of a single element column representative among the plural element columns. The current control means controls the current of each element column individually.

An electronic apparatus of the present invention has at least one light emitting element as the light source and the drive control device described above.

According to the present invention, it is possible to precisely control the current of the light emitting element, without adding such a new component as the temperature sensor.

In addition, requiring no component as a new entry, the electronic apparatus of the present invention will prevent the rise of parts expenses. It is yet possible to stably drive the light source using the light emitting element, because the current of the light emitting element is precisely controlled.

### BRIEF DESCRIPTION OF THE DRAWINGS

The foregoing and other features and advantages of the present invention will become apparent from the following detailed descriptions of the preferred embodiments with the accompanying drawings, which are given by way of illustration only and thus do not limit the present invention. In the drawings, the same reference numeral designates like or corresponding part throughout the several views, and wherein:

FIG. 1 is an explanatory view illustrating an outline of a color thermal printer;

FIG. 2 is a plan view illustrating a structure of an LED two-dimensional array;

FIG. 3 is a graph showing a spectroscopic characterization of LED and a transmission characterization of a filter;

FIG. 4 is a block diagram illustrating an electrical structure of an optical fixing unit;

FIG. 5 is a graph showing a measurement result of temporal change in drive voltage and light amount of LED;

FIG. 6 is a flow chart illustrating procedure of creating a drive profile;

FIG. 7 is a flow chart illustrating procedure of optical fixation;

FIG. 8 is a block diagram illustrating an electrical structure of an optical fixing unit according to another embodiment of the present invention; and

FIG. 9 is a block diagram illustrating an electrical structure of an optical fixing unit according to still another embodiment of the present invention.

### DESCRIPTION OF THE PREFFERED EMBODIMENTS

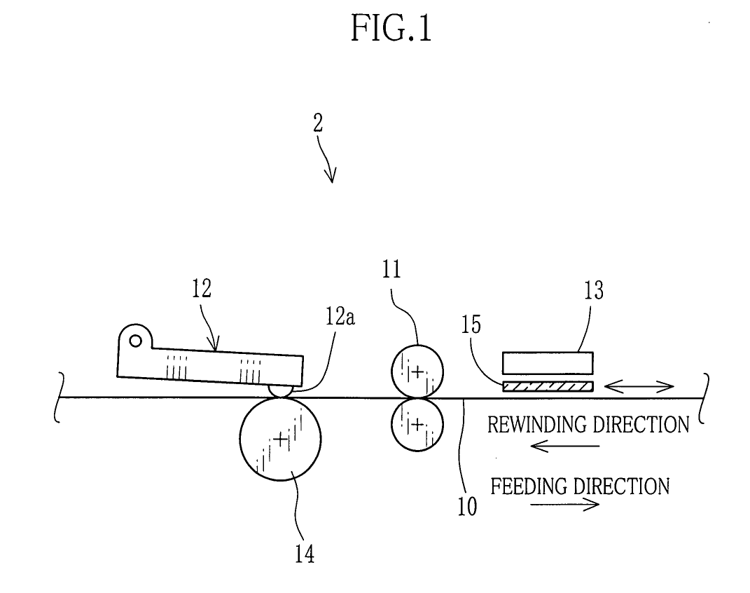

Referring now to FIG. 1, a direct color thermal printer 2 feeds a color thermosensitive recording paper 10 (hereinafter referred to as a recording paper) in feeding and rewinding directions alternately by a feed roller pair 11, with performing a full-color print by a thermal head 12 and a subsequent optical fixation of the recording paper 10 by an optical fixing unit 13.

As is known in the art, the recording paper 10 is formed by sequentially overlaying a cyan thermosensitive coloring layer, a magenta thermosensitive coloring layer, a yellow thermosensitive coloring layer, and a protective layer on a support. The yellow thermosensitive coloring layer, the uppermost coloring layer among three, has the highest heat sensitivity and colors in yellow on application of low heat energy. The cyan thermosensitive coloring layer, the lowermost coloring layer, has the lowest heat sensitivity and colors in cyan on high heat energy.

The yellow thermosensitive coloring layer loses its coloring ability when a near-ultraviolet ray of 420 nm wavelength is applied thereto. The magenta thermosensitive coloring layer, which colors in magenta on the intermediate heat energy between the yellow and cyan thermosensitive coloring layers, loses its coloring ability when an ultraviolet ray of 365 nm wavelength is applied thereto. Note that the recording paper may have another layer, a black thermosensitive coloring layer for example, to form a four-layer structure.

The thermal head 12 is provided with a heat element array 12a which has plural heat elements arranged linearly along a main scanning direction (the width direction of the recording paper 10). The heat element array 12a responds to image data for each single line and heats line by line the recording paper 10 to color each thermosensitive coloring layer.

Opposite the thermal head 12, a platen roller 14 is placed. The platen roller 14 trails the recording paper 10 to rotate, stabilizing the contact between the recording paper 10 and the heat element array 12a. The platen roller 14 is movable in the vertical direction and biased toward the heat element array 12a by a spring (not shown). In feed and discharge of the recording paper 10, the platen roller 14 is moved down by a shift mechanism (not shown) composed of a cam or a solenoid so as to create a gap below the thermal head 12.

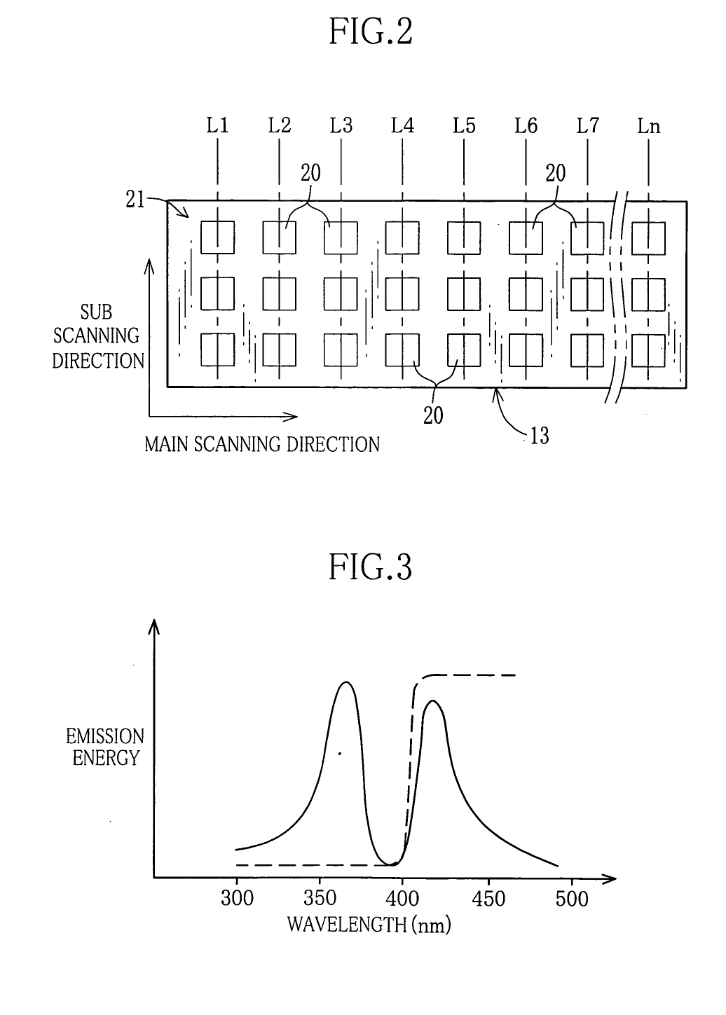

As shown in FIG. 2, the optical fixing unit 13 carries a two dimensional LED array 21, as a light source, in which a number of light emitting diode (LED) 20 are arranged in a matrix. As shown with a solid line on a graph in FIG. 3, several blue LEDs as LED 20 have different peak emissions, one at around 365 nm (as a magenta fixing light) and another at around 420 nm (as a yellow fixing light). In the two dimensional LED array 21, three LEDs 20 come into line along a sub scanning direction (the feeding direction of the recording paper 10) to form an LED column L, a plurality of which are arranged in the main scanning direction.

In FIG. 1, a filter 15 is disposed below the optical fixing unit 13. The filter 13 is able to block the light below approximately 400 nm wavelength and move between an interposing position, between the optical fixing unit 13 and feeding path of the recording paper 10, and a retreating position away from the interposing position.

In the optical fixation of the yellow thermosensitive coloring layer, the filter 15 moves to the interposing position. This blocks the light, from the two dimensional LED array 21, within the wavelength range of magenta fixing. Therefore, only the yellow fixing light can go through the filter 15 to reach the recording paper 10 and the unrecorded magenta thermosensitive coloring layer will avoid getting fixed during the optical fixation of the yellow thermosensitive coloring layer.

In the optical fixation of the magenta thermosensitive coloring layer, the filter 15 moves to the retreating position. This allows the yellow and magenta fixing light, from the two dimensional LED array 21, to reach the recording paper 10. The yellow fixing light causes no problem, at this point, because the yellow thermosensitive coloring layer is already fixed.

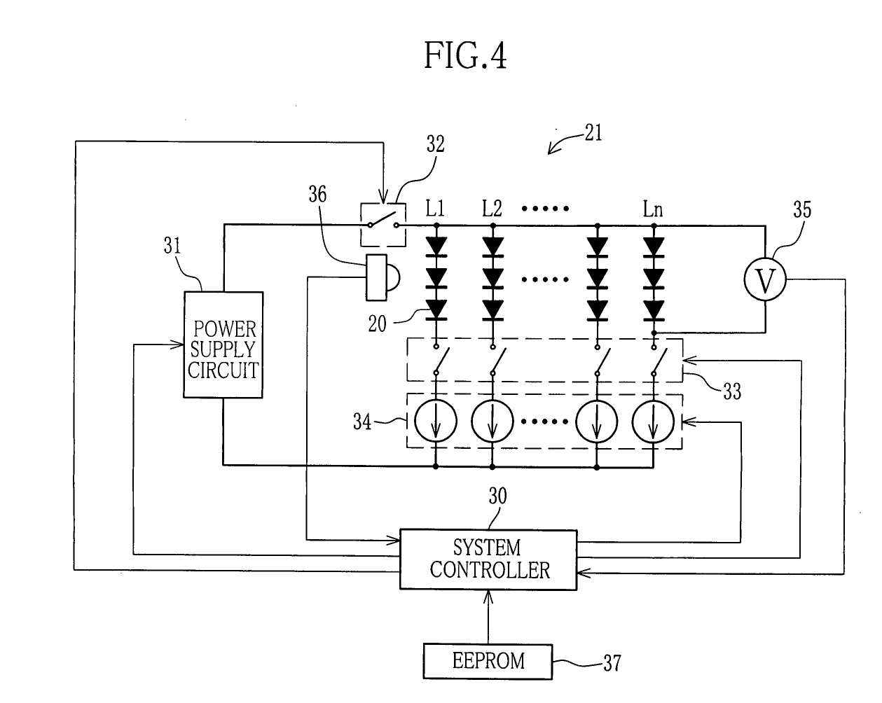

Referring to FIG. 4, a system controller 30 comprehensively controls the direct color thermal printer 2. The system controller 30 comprises a power supply circuit 31 for powering the two dimensional LED array 21, a power switch 32 for making a connection of the power supply circuit 31 with the two dimensional LED array 21, a shift register, a latch array, an AND gate array (none of three shown), and others.

The system controller 30 is connected to an array of drive control switches 33 for turning on and off each LED column L, a constant current source 34 for driving three LEDs 20 in each LED column L by constant current through a transistor (not shown), a voltmeter 35 for measuring drive voltage VF of the LED column L, a light amount sensor 36 for measuring light amount P of the two dimensional LED array 21, and an EEPROM 37. The light amount sensor 36 is mounted in the printer at the time of measurement.

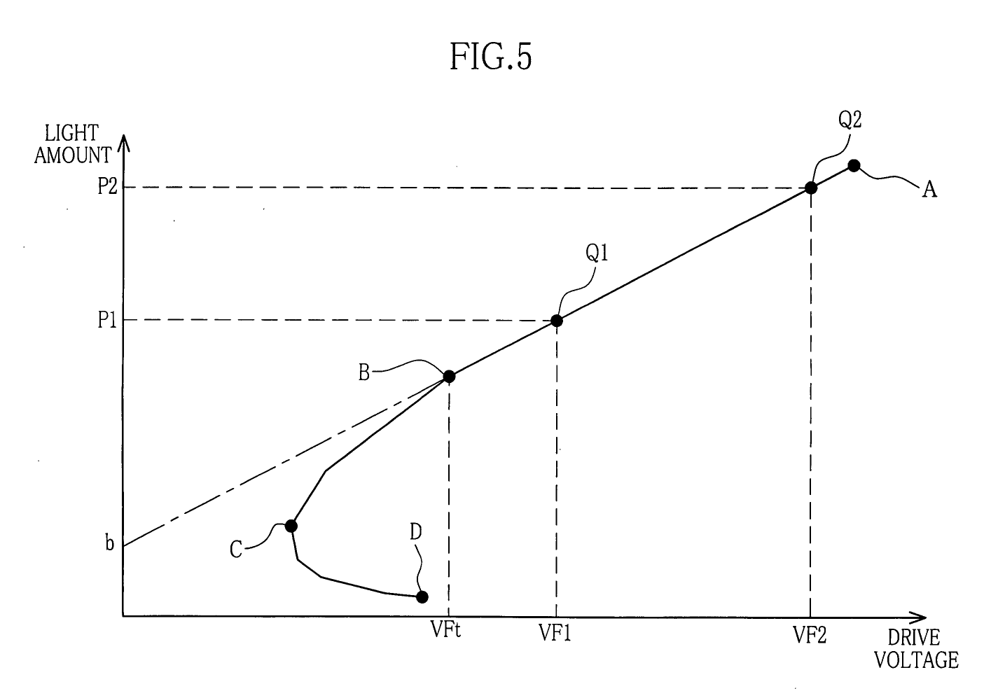

The power switch 32 and one of the drive control switches 33 are turned on to illuminate three LEDs 20 in a representative LED column L. Then, the voltmeter 35 and the light amount sensor 36 are activated to measure temporal change in the drive voltage VF and the light amount P. Boosting current in this state will increase luminance (i.e. light amount) of LED 20. Beyond a certain value of current, however, the luminance is saturated and hardly increased. When driving the LED column L by a maximum current to saturate luminance, such a response as shown in FIG. 5 is obtained. Namely, the light amount P is linearly decreasing, along with decreasing of the drive voltage VF, from Point A of the measurement start to Point B and is nonlinearly decreasing from Point B to Point C. At Point C, the drive voltage VF becomes minimum but is increasing past Point C. Then at Point D, LED 20 culminates in breakage.

In FIG. 5, any two points Q1 and Q2 are selected within the region where the response becomes linear, i.e. Point A and B, and the drive voltages VF1, VF2 and the light amounts P1, P2 are measured at Q1 and Q2 by the system controller 30. These measured values are used to derive a slope a and an intercept b of a first-order equation, which represents the linear response, in the formulas of
a=(P2−P1)/(VF2−VF1)
b=P1−aVF1=P2−aVF2.

Also, a drive voltage VFt (hereinafter referred to as threshold voltage) is measured by the system controller 30 at a point where a ratio Δ of the variation in the drive voltage VF to that in the light amount P exceeds the slope a, in other wards, where the linear response changes to the nonlinear. Namely, it is Point B. After measuring the threshold voltage VFt at Point B, the power switch 32 and the array of drive control switches 33 are turned off to finish measuring.

The slope a, the intercept b, and the threshold voltage VFt obtained by the system controller 30 are written, as a drive profile, to the EEPROM 37 by a ROM writer. These processes are carried out before shipment. Note that the light amount sensor 36 is not a part of the printer but a measuring instrument.

When the direct color thermal printer 2 activates the two dimensional LED array 21 for the optical fixation, the system controller 30 refers to the drive profile stored in the EEPROM 37 and obtains a drive voltage VF for a targeted light amount P. Subsequently, the system controller 30 drives the constant current source 34 to control the current I of the LED column L in the two dimensional LED array 21 such that the voltage in the LED column L becomes the obtained drive voltage VF and yet does not become below the threshold voltage VFt.

Here, the drive voltage VF for the targeted light amount P is derived from the formula of
VF=(P−b)/a,
with using the slope a and the intercept b obtained by the system controller 30.

Also, the current I is derived from the formula of
I=W/VF,
wherein W is electric power from the power supply circuit 31.

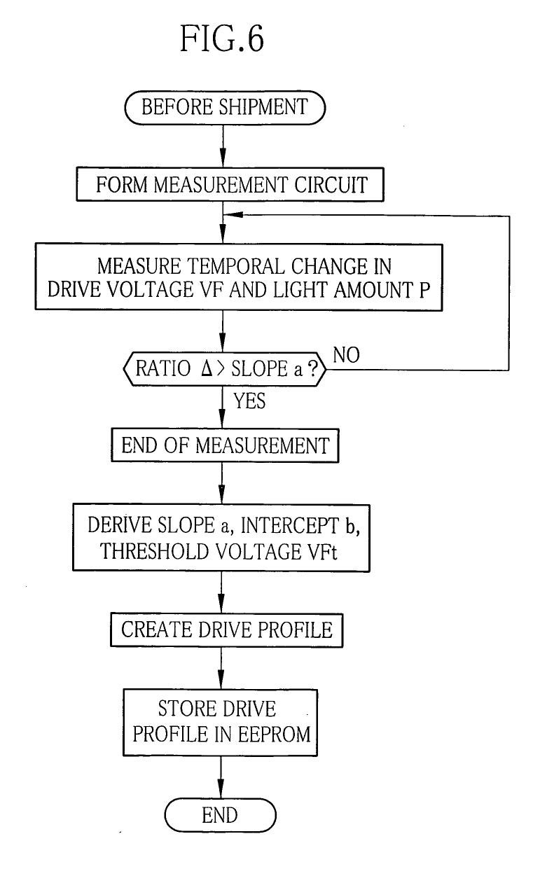

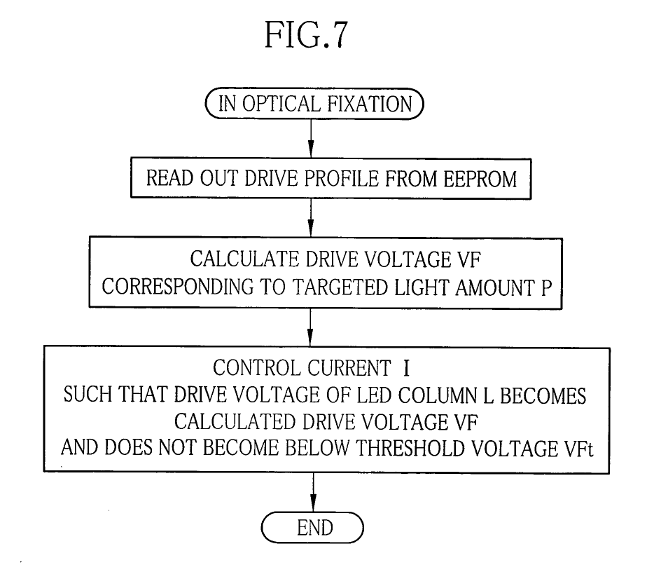

Referring to flow charts in FIGS. 6 and 7, the operation of the direct color thermal printer 2 having the above mentioned structure is described. Before shipment of the direct color thermal printer 2, the light amount sensor 36 as the measuring instrument is attached to form the measuring circuit shown in FIG. 4. Then, the power switch 32 and one of the drive control switches 33 are turned on to illuminate three LEDs 20 in the representative LED column L. With the maximum current applied to LED 20, temporal change in the drive voltage VF and the light amount P is measured by the voltmeter 35 and the light amount sensor 36.

The system controller 30 obtains the drive voltages VF1, VF2 and the light amounts P1, P2 of Points Q1 and Q2, which are selected within Points A and B where the response is linear. The system controller 30 also derives the slope a and the intercept b of the first-order equation that represents the linear response. After measuring the threshold voltage VFt at Point B where the linear response changes to the nonlinear, the power switch 32 and the array of drive control switches 33 are turned off to finish measuring.

Subsequently, the slope a, the intercept b, and the threshold voltage VFt obtained by the system controller 30 are written, as the drive profile, to the EEPROM 37 by the ROM writer. After writing the drive profile, the light amount sensor 36 is detached and the direct color thermal printer 2 will be shipped as a finished product.

The direct color thermal printer 2 after shipment permits the feed roller pair 11 to rotate, upon starting operation of the image recording, to feed the recording paper 10 toward the thermal head 12. As the recording paper 10 reaches at a start position of the image recording, the feed roller pair 11 temporarily stops rotating. After that, the platen roller 14 moves upward by the action of the shift mechanism so as to hold the recording paper 2 with the heat element array 12a. While the feed roller pair 11 resumes rotating in this state to feed the recording paper 2 in the feeding direction, the heat element array 12a generates heat based on the image data to be recorded so that yellow images are recorded on the yellow thermosensitive coloring layer in the recording paper 10.

After the yellow image recording, the recording paper 10 is conveyed to face the optical fixing unit 13 and then the platen roller 14 stops rotating. Thereafter, the platen roller 14 moves downward, by the shift mechanism, to free the recording paper 10 from holding with the heat element array 12a. At the same time, the filter 15 moves to the interposing position.

Then, the feed roller pair 11 counterrotates and feeds the recording paper 10 in the rewinding direction. With feeding, the system controller 30 illuminates LED 20 to optically fix the yellow thermosensitive coloring layer with the recorded image.

As the recording paper 10 goes back to face the heat element array 12a after the optical fixation of the yellow thermosensitive coloring layer, the feed roller pair 11 stops counter rotating. The platen roller 14 moves upward, as with the yellow image recording, to hold the recording paper 2 with the heat element array 12a. The feed roller pair 11 rotates again in this state to feed the recording paper 2 in the feeding direction, thus magenta images are recorded on the magenta thermosensitive coloring layer in the recording paper 10.

After the magenta image recording, the recording paper 10 is conveyed to face the optical fixing unit 13 again and then the feed roller pair 11 stops rotating. The filter 15 also moves to the retreating position. Then, the feed roller pair 11 counterrotates to feed the recording paper 10 in the rewinding direction, alike the yellow image fixation. The system controller 30 illuminates LED 20 and optically fixes the magenta thermosensitive coloring layer with the recorded image.

When the recording paper 10 once again moves to face the heat element array 12a after the optical fixation of the magenta thermosensitive coloring layer, the feed roller pair 11 stops counterrotating. Cyan images are recorded on the cyan thermosensitive coloring layer in the recording paper 10, as with the yellow and magenta image recordings. The recording paper 10 being recorded the cyan image is advanced in the feeding direction by the feed roller pair 11, cut into a predetermined print size by a cutter (not shown), and then ejected.

In the optical fixations of the yellow and magenta thermosensitive coloring layers, the system controller 30 reads out the drive profile stored in the EEPROM 37 to obtain the drive voltage VF for the targeted light amount P. The system controller 30 drives the constant current source 34 and controls the current I of the LED column L in the two dimensional LED array 21 such that the voltage in the LED column L becomes the drive voltage VF and yet does not become below the threshold voltage VFt.

As described above, the drive profile for obtaining the drive voltage VF for the targeted light amount P is created by the system controller 30 and stored in the EEPROM 37 before the shipment of the direct color thermal printer 2. In the optical fixation after shipment, the drive voltage VF is obtained with referring to the stored drive profile. The current I of the LED column L in the two dimensional LED array 21 is controlled such that the voltage in the LED column L becomes the drive voltage VF. Therefore, it is possible to precisely control the current of LED 20. Also, no component is added in the direct color thermal printer 2 as a new entry because the light amount sensor 36, used as the measurement instrument, is detached from the outgoing product. Further, there is no possibility of light emitting elements to move into Point D in FIG. 5 and break, because the current I is controlled such that the voltage in the LED column L does not become below the threshold voltage VFt.

In addition, Plural LED 20 in each LED column L can be arranged in zigzags rather than in lines, as long as they are electrically connected in series. Besides, the number of LED 20 to form the LED column L of the above embodiment may be changed appropriately.

In the preferred embodiment, a single line of LED 20 is driven for measurement of temporal change in the drive voltage VF and the light amount P. Then, the slope a, the intercept b, and the threshold voltage VFt are obtained based on the measurement result to create the drive profile. However, several lines of LED 20 may be driven and the same measurement may be done in each line. Thus, the slopes a, the intercepts b, and the threshold voltages VFt as the measurement results are respectively averaged to create the drive profile.

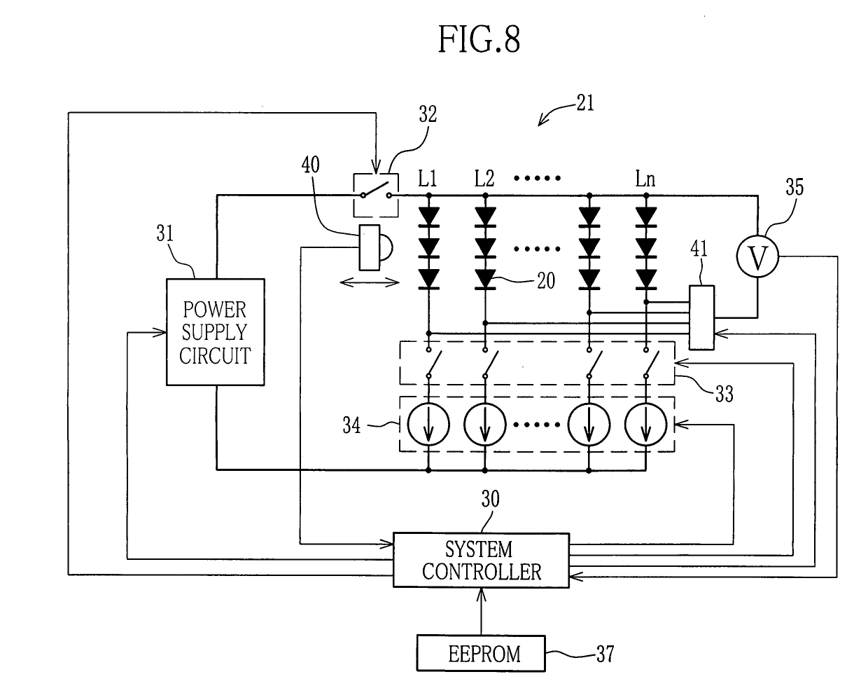

Or, as shown in FIG. 8, a light amount sensor 40 movable in the main scanning direction may be used. In this case, every LED column L is illuminated in sequence and temporal change in the drive voltage VF and the light amount P is measured to each LED column L. Thus obtained slope a, intercept b, and threshold voltage VFt of each LED column L become the basis for the drive profile. Here, the voltmeter 35 is connected to a switching circuit 41 controlled by the system controller 30, enabling to selectively measure the drive voltage VF of each LED column L. In the optical fixation of the direct color thermal printer 2 after shipment, the system controller 30 operates the switching circuit 42 to switch at a predetermined interval so as to individually control the current of LED 20 in each LED column L. This enables the more precise current control over LED 20. Note that the two dimensional LED array 21 may be moved in the direction of the LED column L, unless using the movable light amount sensor 40.

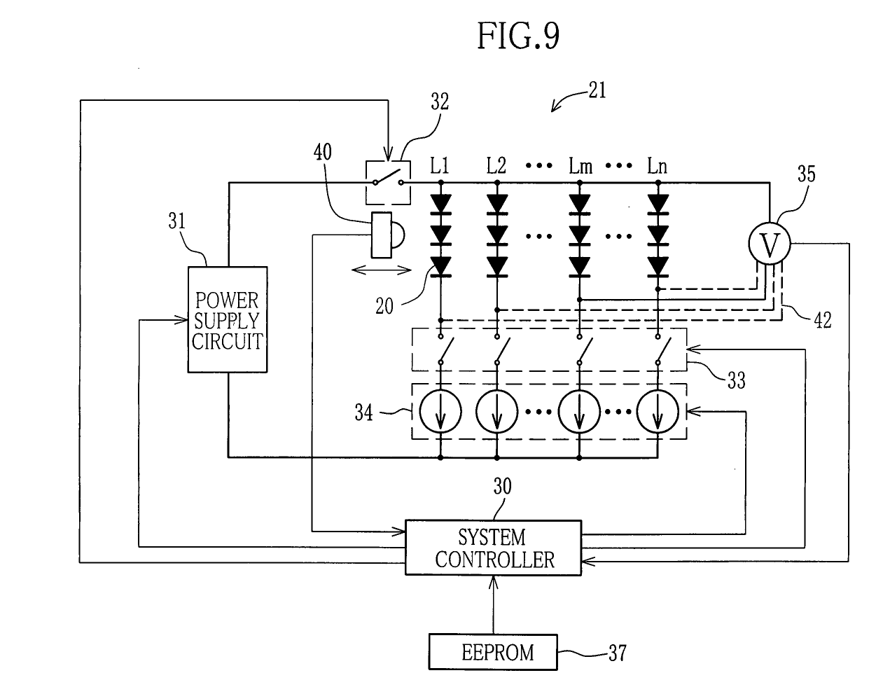

Further, as shown in FIG. 9, a test land 42 to connect the voltmeter 41 with each LED column L (as shown by the dashed lines) can be provided on the substrate of the two dimensional LED array 21, instead of the switching circuit 41. Every LED column L is only measured before shipment about the drive voltage VF. The measured values are normalized by a drive voltage VFm of a representative LED column Lm and become the basis for the drive profile. In this case, the test land 42 and the light mount sensor 40 are detached from the direct color thermal printer 2 before shipment. At the optical fixation after shipment, only the drive voltage VFm of the LED column Lm is measured by the voltmeter 35. This measurement result is used to derive the drive voltage VF for all other LED columns upon referring to the drive profile. Then, the current of LED 20 in each LED column L is individually controlled likewise the instance of FIG. 8. This structure eliminates the switching circuit 41 and its wirings to each LED column L, providing the more simplified circuitry than the structure in FIG. 8 does.

The preferred embodiment is explained with the direct color thermal printer 2, which has the optical fixing unit 13 using the two dimensional LED array 21 as the light source. However, the present invention is not limited to this but applicable to other electronic apparatuses such as a liquid crystal display using a light emitting element as a source of backlight, a variety of lighting devices, a warning device using a light emitting element as tail lamp for automobile use, and the like.

As described so far, the present invention is not to be limited to the above embodiments, and all matter contained herein is illustrative and does not limit the scope of the present invention. Thus, obvious modifications may be made within the spirit and scope of the appended claims.

1. A drive control method for at least one light emitting element, comprising the steps of:
measuring temporal change in drive voltage and light amount of said light emitting element while driving said light emitting element by constant current;
creating and storing a drive profile which is used to obtain a target drive voltage corresponding to targeted light amount, according to result of said measuring;
deriving said target drive voltage upon referring to said drive profile; and
controlling current of said light emitting element so as drive voltage of said light emitting element to become said target drive voltage when illuminating said light emitting element.

2. The drive control method as claimed in claim 1, further comprising the steps of:
obtaining a threshold voltage at a point where response of said light amount to variation of said drive voltage changes from linear to nonlinear, according to said result of said measuring;
storing said threshold voltage together with said drive profile; and
controlling said current of said light emitting element so as said drive voltage of said light emitting element not to become below said threshold voltage when illuminating said light emitting element.

3. The drive control method as claimed in claim 2, wherein said drive profile includes a slope and an intercept of a first-order equation representing a linear portion of said response.

4. The drive control method as claimed in claim 2, wherein said light emitting element is driven by a maximum current for maximum light emission, during said measuring of said drive voltage and said light amount.

5. The drive control method as claimed in claim 2, wherein said light emitting element is plural in number, said plural light emitting elements being serially connected to form a plurality of element columns, said measuring step and said controlling step being performed in each element column.

6. The drive control method as claimed in claim 5, wherein said drive profile is created based on normalizing drive voltage of each element column by that of a single element column representative among said element columns.

7. A drive control device for at least one light emitting element, comprising:
a data processing means for creating a drive profile which is used to obtain a target drive voltage corresponding to targeted light amount, according to a measurement result of temporal change in drive voltage and light amount of said light emitting element while driving said light emitting element with constant current;
a memory means for storing said drive profile; and
a current control means for controlling current of said light emitting element so as drive voltage of said light emitting element to become said target drive voltage when illuminating said light emitting element, after obtaining said target drive voltage upon referring to said drive profile stored in said memory means.

8. The drive control device as claimed in claim 7, wherein said data processing means obtains a threshold voltage at a point where response of said light amount to variation of said drive voltage changes from linear to nonlinear, according to said measurement result, said memory means storing said threshold voltage together with said drive profile, said current control means controlling said current of said light emitting element so as said drive voltage of said light emitting element not to become below said threshold voltage.

9. The drive control device as claimed in claim 8, wherein said drive profile includes a slope and an intercept of a first-order equation representing a liner portion of said response.

10. The drive control device as claimed in claim 8, wherein said light emitting element is plural in number, said plural light emitting elements being serially connected to form a plurality of element columns, said data processing and said current controlling being performed in each element column.

11. The drive control device as claimed in claim 10, wherein said drive profile is created based on normalizing drive voltage of each element column by that of a single element column representative among said element columns.

12. An electronic apparatus using at least one light emitting element as a light source, comprising:
a data processing means for creating a drive profile which is used to obtain a target drive voltage corresponding to targeted light amount, according to a measurement result of temporal change in drive voltage and light amount of said light emitting element while driving said light emitting element with constant current;
a memory means for storing said drive profile; and
a current control means for controlling current of said light emitting element so as drive voltage of said light emitting element to become said target drive voltage when illuminating said light emitting element, after obtaining said target drive voltage upon referring to said drive profile stored in said memory means.

13. The electronic apparatus as claimed in claim 12, wherein said data processing means obtains a threshold voltage at a point where response of said light amount to variation of said drive voltage changes from linear to nonlinear, according to said measurement result, said memory means storing said threshold voltage together with said drive profile, said current control means controlling said current of said light emitting element so as drive voltage of said light emitting element not to become below said threshold voltage.

14. The electronic apparatus as claimed in claim 13, wherein said drive profile includes a slope and an intercept of a first-order equation representing a linear portion of said response.

15. The electronic apparatus as claimed in claim 13, wherein said light emitting element is plural in number, said plural light emitting elements being serially connected to form a plurality of element columns, said data processing and said current controlling being performed in each element column.

16. The electronic apparatus as claimed in claim 15, wherein said drive profile is created based on normalizing drive voltage of each element column by that of a single element column representative among said element columns.
